(19) United States
(12) Patent Application Publication
(10) Pub. No.: US 2023/0034082 A1
(43) Pub. Date: Feb. 2, 2023

(54) DAMPER DEVICE

(71) Applicant: EXEDY Corporation, Osaka (JP)

(72) Inventor: Hiroshi UEHARA, Osaka (JP)

(21) Appl. No.: 17/856,107

(22) Filed: Jul. 1, 2022

(30) Foreign Application Priority Data
Aug. 2, 2021 (JP) 2021-126815

(51) Int. Cl. F16F 15/123; F16F 15/129

(52) U.S. Cl. CPC F16F 15/1238; F16F 15/1297; F16D 13/644; F16F 2222/04

(57) ABSTRACT

A damper device includes a hub flange, an input rotor, an elastic member, and a contact assist mechanism. The hub flange includes internal teeth meshed with external teeth of a power transmission shaft. The input rotor is disposed to be rotatable relative to the hub flange. The elastic member elastically couples the input rotor and the hub flange. The contact assist mechanism is configured to cause contact between the internal teeth of the hub flange and the external teeth of the power transmission shaft.

### CROSS-REFERENCE TO RELATED APPLICATIONS

This application claims priority to Japanese Patent Application No. 2021-126815 filed Aug. 2, 2021. The entire contents of that application are incorporated by reference herein in their entirety.

### TECHNICAL FIELD

The present invention relates to a damper device.

### BACKGROUND ART

An engine-embedded vehicle and so forth inhibit fluctuations in rotation of an engine by a damper device installed in a torque transmission path (see Japan Laid-open Patent Application Publication No. 2011-226572). Besides, the damper device, used in Japan Laid-open Patent Application Publication No. 2011-226572, has a torque limiter function in order to prevent transmission of an excessive torque from an output side to an engine side in engine start and so forth.

The damper device is attached to a flywheel. Besides, a power transmission shaft (e.g., an input shaft of a transmission) is spline-coupled to a spline hole provided in the middle of the damper device. When described in detail, the internal teeth of a hub flange of the damper device and the external teeth of the power transmission shaft are meshed, whereby the power transmission shaft is spline-coupled to the damper device. Accordingly, a power is transmitted from the damper device to the power transmission shaft.

The damper device described above has a drawback that in a no-load condition, fluctuations in rotation of the engine cause collision between the internal teeth of the hub flange and the external teeth of the power transmission shaft, whereby collision sounds are produced.

In view of the above, it is an object of the present invention to inhibit production of such collision sounds as described above.

### BRIEF SUMMARY

A damper device according to an aspect of the present invention is configured to be attached to a power transmission shaft including external teeth. The damper device includes a hub flange, an input rotor, an elastic member, and a contact assist mechanism. The hub flange includes internal teeth to be meshed with the external teeth of the power transmission shaft. The input rotor is disposed to be rotatable relative to the hub flange. The elastic member elastically couples the input rotor and the hub flange. The contact assist mechanism is configured to cause contact between the internal teeth of the hub flange and the external teeth of the power transmission shaft.

According to this configuration, the contact assist mechanism causes contact between the internal teeth of the hub flange and the external teeth of the power transmission shaft. Because of this, even when engine rotation fluctuates in a no-load condition, the internal teeth and the external teeth can be kept in contact with each other, whereby collision sounds can be prevented from being produced between the internal teeth and the external teeth.

Preferably, the contact assist mechanism is an urging member configured to urge the hub flange to tilt the hub flange such that a rotational axis of the hub flange is tilted with respect to a rotational axis of the power transmission shaft.

Preferably, the urging member includes a first urging member and a second urging member. The first urging member urges the hub flange to a first side in an axial direction. The second urging member is disposed apart from the first urging member at an interval in a circumferential direction. The second urging member urges the hub flange to a second side in the axial direction.

Preferably, the elastic member includes a first elastic member and a second elastic member. The first elastic member is disposed in a compressed state to urge the input rotor in a first rotational direction. The second elastic member is disposed in a compressed state to urge the input rotor in a second rotational direction. The second elastic member is smaller in stiffness than the first elastic member. The contact assist mechanism is formed by the first and second elastic members.

Preferably, the damper device further includes a weight member attached to part of an outer peripheral end portion of the hub flange. The contact assist mechanism is formed by the weight member.

Overall, according to the present invention, it is possible to inhibit collision sounds from being produced between the internal teeth of the hub flange and the external teeth of the power transmission shaft.

### BRIEF DESCRIPTION OF THE DRAWINGS

FIG. 1 is a cross-sectional view of a damper device.

FIG. 2 is another cross-sectional view of the damper device.

FIG. 3 is a schematic diagram showing a positional relation between an input rotor and a hub flange.

FIG. 4 is a front view of the hub flange.

FIG. 5 is a cross-sectional closeup view of a damper device.

FIG. 6 is a diagram showing a contact state between internal teeth and external teeth on a first side in an axial direction.

FIG. 7 is a diagram showing a contact state between the internal teeth and the external teeth on a second side in the axial direction.

FIG. 8 is a front view of a hub flange according to a modification.

### DETAILED DESCRIPTION

A damper device according to an embodiment of the present invention will be hereinafter explained with reference to drawings. It should be noted that in the following explanation, the term “axial direction” refers to an extending direction of the rotational axis of the damper device. On the other hand, the term “circumferential direction” refers to a circumferential direction of an imaginary circle about the rotational axis, whereas the term “radial direction” refers to a radial direction of the imaginary circle about the rotational axis.

### Entire Configuration

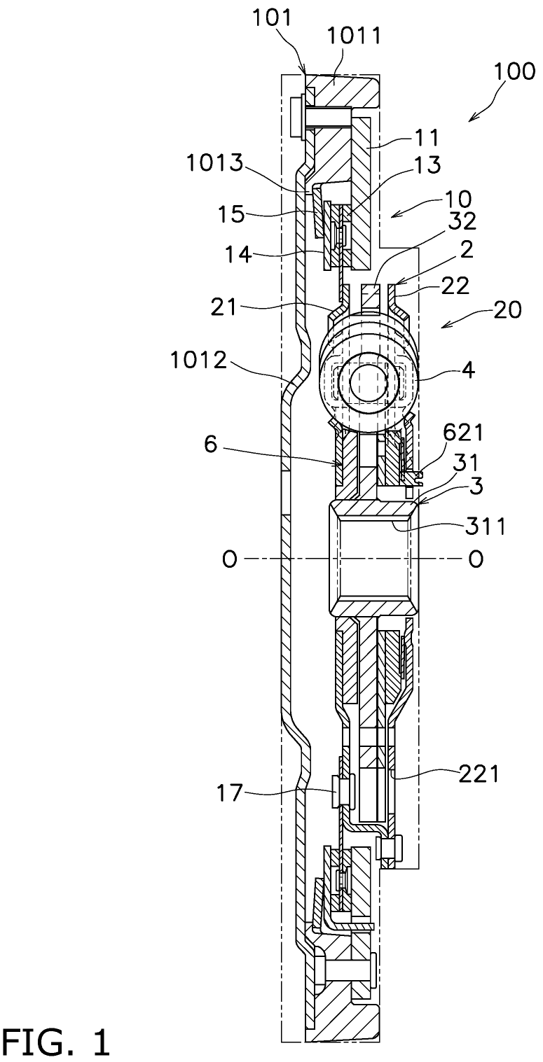

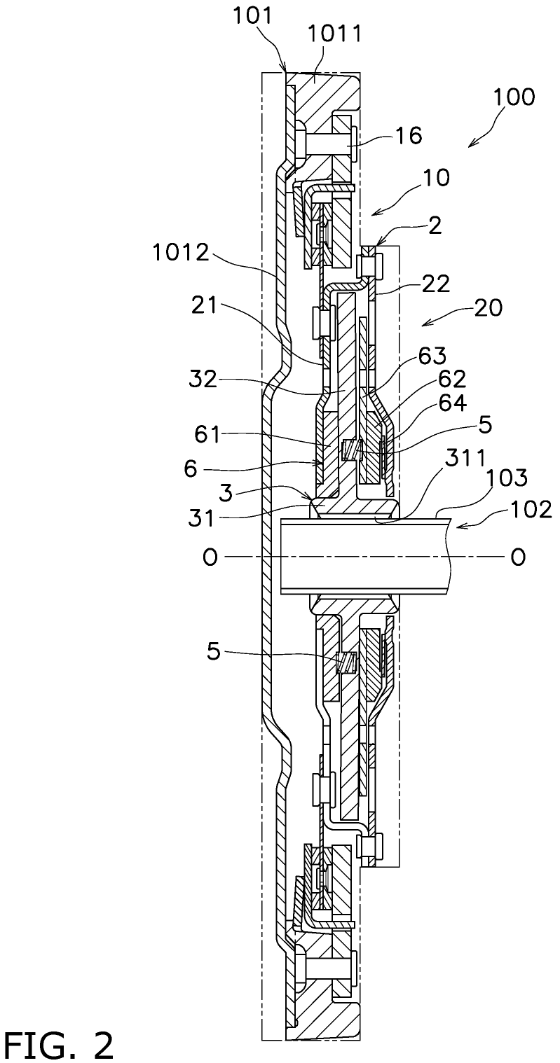

FIGS. 1 and 2 are cross-sectional views of a torque limiter embedded damper device 100 (hereinafter simply referred to as “damper device 100”) according to the present preferred embodiment. In FIGS. 1 and 2, an engine (not shown in the drawings) is disposed on the left side of the damper device 100, whereas a drive unit (not shown in the drawings), including an electric motor, a transmission, and so forth, is disposed on the right side of the damper device 100.

The damper device 100 is a device provided between a flywheel 101 and an input shaft 102 (exemplary power transmission shaft) of the drive unit in order to limit a torque transmitted between the engine and the drive unit and attenuate rotational fluctuations.

The flywheel 101 includes an inertia ring 1011 and a flexible plate 1012. The damper device 100 is fixed to the inertia ring 1011 by at least one bolt and/or so forth.

The damper device 100 includes a torque limiter unit 10 and a damper unit 20.

### Torque Limiter Unit 10

The torque limiter unit 10 is disposed radially outside the damper unit 20. The torque limiter unit 10 limits a torque transmitted between the flywheel 101 and the damper unit 20. The torque limiter unit 10 includes a support plate 11, a friction disc 13, a pressure plate 14, and a cone spring 15.

The support plate 11 is fixed at the outer peripheral part thereof to the flywheel 101. When described in detail, the support plate 11 is fixed to the inertia ring 1011 of the flywheel 101 by a plurality of bolts 16.

The friction disc 13, the pressure plate 14, and the cone spring 15 are disposed axially between the support plate 11 and an annular protrusion 1013 of the flywheel 101. It should be noted that the annular protrusion 1013 protrudes radially inward from the inner peripheral surface of the inertia ring 1011. The annular protrusion 1013 has an annular shape and extends in the circumferential direction.

The friction disc 13 includes a core plate and a pair of friction members fixed to both lateral surfaces of the core plate. The friction disc 13 is herein fixed at the inner peripheral part thereof to the damper unit 20 by a plurality of rivets 17. The pressure plate 14 and the cone spring 15 are disposed between the friction disc 13 and the annular protrusion 1013.

The pressure plate 14 has an annular shape. The pressure plate 14 is disposed on the annular protrusion 1013 side of the friction disc 13.

The cone spring 15 is disposed between the pressure plate 14 and the annular protrusion 1013. The cone spring 15 presses the friction disc 13 against the support plate 11 through the pressure plate 14.

### Damper Unit 20

The damper unit 20 includes an input rotor 2, a hub flange 3, a plurality of elastic members 4, a contact assist mechanism 5, and a hysteresis generating mechanism 6.

### Input Rotor 2

The input rotor 2 is disposed to be rotatable about the rotational axis (O). The input rotor 2 includes a first input plate 21 and a second input plate 22. The first and second input plates 21 and 22, each of which is made in shape of a disc including a hole in the center part thereof, are disposed axially apart from each other at an interval. The first and second input plates 21 and 22 are non-rotatable relative to each other and are axially immovable from each other.

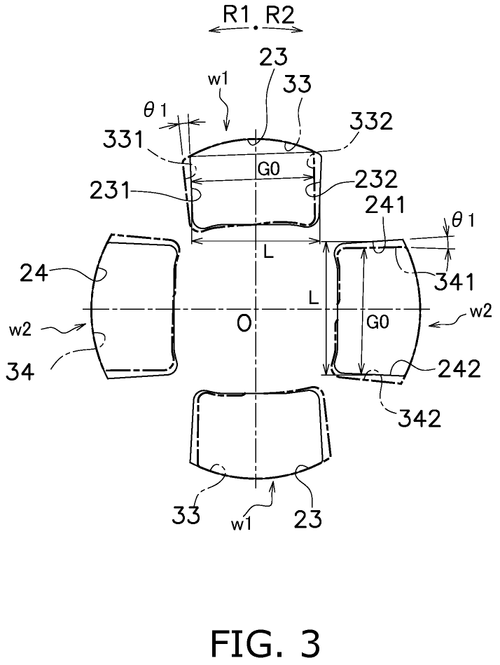

FIG. 3 is a schematic diagram showing a positional relation between the input rotor 2 and the hub flange 3. As shown in FIG. 3, each of the first and second input plates 21 and 22 includes a pair of first support portions 23 and a pair of second support portions 24. The pair of first support portions 23 of the first input plate 21 and the pair of first support portions 23 of the second input plate 22 are identical not only in position but also in shape. Likewise, the pair of second support portions 24 of the first input plate 21 and the pair of second support portions 24 of the second input plate 22 are identical not only in position but also in shape.

The pair of first support portions 23 is opposed to each other with respect to the rotational axis O. In other words, the pair of first support portions 23 is disposed at an angular pitch of 180 degrees about the rotational axis O. Likewise, the pair of second support portions 24 is disposed at an angular pitch of 180 degrees about the rotational axis O. The pair of first support portions 23 and the pair of second support portions 24 are disposed at an angular pitch of 90 degrees about the rotational axis O. Each support portion 23, 24 includes a hole axially penetrating therethrough and an edge part formed by cutting and raising the inner and outer peripheral edges of the hole.

Each first support portion 23 includes an R1 support surface 231 on one end thereof located on a first rotation directional side (hereinafter simply referred to as “R1 side”) and includes an R2 support surface 232 on the other end thereof located on a second rotation directional side (hereinafter simply referred to as “R2 side”). Likewise, each second support portion 24 includes an R1 support surface 241 on one end thereof located on the first rotation directional side and an R2 support surface 242 located on the second rotation directional side.

The circumferential length of each support portion 23, 24 (distance between the R1 support surface and the R2 support surface) is L. Besides, each support surface 231, 232, 241, 242 enables each elastic member 4 (to be described) to make contact therewith at one end surface thereof.

It should be noted that in FIG. 3, the first and second support portions 23 and 24 are depicted with solid line, whereas first and second accommodation portions 33 and 34 (to be described) of the hub flange 3 are depicted with dashed-dotted line.

### Hub Flange 3

As shown in FIGS. 1 and 2, the hub flange 3 includes a hub 31 and a flange 32. The hub flange 3 is disposed to be rotatable about the rotational axis O. The hub flange 3 is rotatable relative to the input rotor 2 in a predetermined angular range. It should be noted that the hub flange 3 is configured not to be rotated relative to the input rotor 2 at a greater angle than the predetermined angular range by a stopper mechanism.

The hub 31 has a tubular shape and is provided with a spline hole in the center part thereof. In other words, the hub 31 includes internal teeth 311 on the inner peripheral surface thereof. The input shaft 102 is spline-coupled to the spline hole of the hub 31. In other words, the input shaft 102 includes external teeth 103 on the outer peripheral surface thereof. The internal teeth 311 of the hub 31 are meshed with the external teeth 103 of the input shaft 102. It should be noted that the input shaft 102 is a solid member having a columnar shape.

The hub 31 penetrates both holes provided in the center parts of the first and second input plates 21 and 22.

The flange 32 has a disc shape. The flange 32 is disposed axially between the first and second input plates 21 and 22.

The flange 32 extends radially outward from the outer peripheral surface of the hub 31. The flange 32 is integrally formed with the hub 31. In other words, the flange 32 is integrated with the hub 31 as a single member. Therefore, the hub 31 and the flange 32 are unitarily rotated with each other. It should be noted that in the present preferred embodiment, the hub 31 and the flange 32 are provided as a single member, but alternatively, can be provided as separate members.

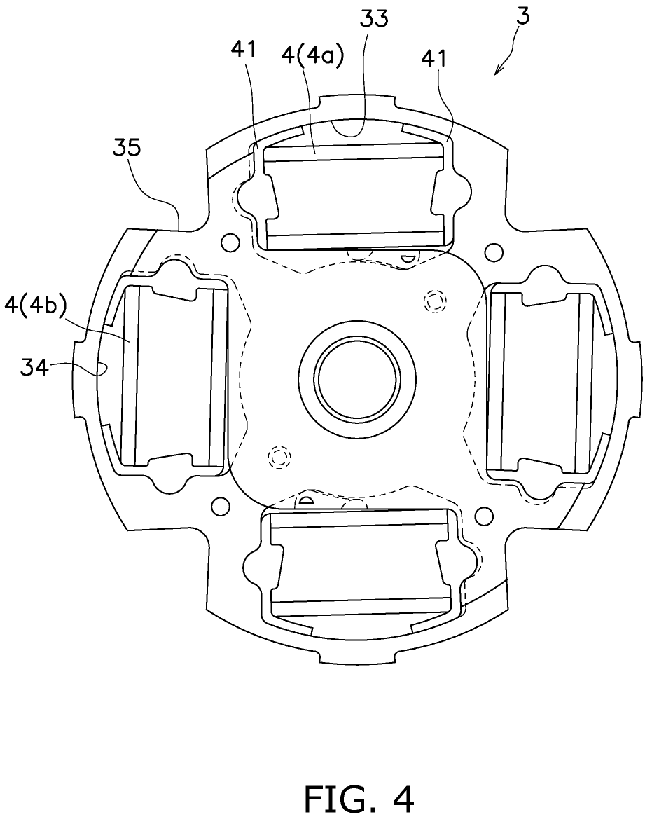

FIG. 4 is a front view of the hub flange. As shown in FIG. 4, the hub flange 3 includes a pair of first accommodation portions 33 and a pair of second accommodation portions 34. Besides, the hub flange 3 includes a plurality of cutouts 35.

As shown in FIG. 3, the pair of first accommodation portions 33 is disposed in corresponding positions to the pair of first support portions 23. On the other hand, the pair of second accommodation portions 34 is disposed in corresponding positions to the pair of second support portions 24. When explained in more detail, in a neutral condition (at a torsion angle of 0 degree) that an angle of relative rotation between the input rotor 2 and the hub flange 3 is 0 degree, and in other words, torsion is not caused between the input rotor 2 and the hub flange 3, the pair of first accommodation portions 33 is disposed to overlap in part the pair of first support portions 23 and be offset (or displaced) from the pair of first support portions 23 to the R1 side by an angle θ1 as seen in the axial direction. On the other hand, the pair of second accommodation portions 34 is disposed to overlap in part the pair of second support portions 24 and be offset (or displaced) from the pair of second support portions 24 to the R2 side by the angle θ1 as seen in the axial direction.

Each accommodation portion 33, 34 is an approximately rectangular hole that the outer peripheral part thereof is made in shape of a circular arc. As shown in FIG. 3, each first accommodation portion 33 includes an R1 accommodation surface 331 on one end thereof located on the R1 side and includes an R2 accommodation surface 332 on the other end thereof located on the R2 side. Likewise, each second accommodation portion 34 includes an R1 accommodation surface 341 on one end thereof located on the R1 side and includes an R2 accommodation surface 342 on the other end thereof located on the R2 side.

In each accommodation portion 33, 34, the circumferential length of the hole (distance between the R1 accommodation surface 331, 341 and the R2 accommodation surface 332, 342) is set to be L in similar manner to the length of the hole in each support portion 23, 24. Besides, each accommodation surface 331, 332, 341, 342 enables each elastic member 4 (to be described) to make contact therewith at one end surface thereof.

As shown in FIG. 4, each cutout 35 is disposed between circumferentially adjacent accommodation portions 33 and 34. Each cutout 35 is recessed radially inward from the outer peripheral surface of the flange 32 at a predetermined depth. The cutouts 35 are provided in corresponding positions to the rivets 17 by which the friction disc 13 and the first input plate 21 are coupled to each other. Therefore, the torque limiter unit 10 and the damper unit 20, assembled in different steps, can be fixed to each other by the rivets 17 with use of assembling holes 221 of the second input plate 22 and the cutouts 35 of the flange 32.

### Elastic Members 4

As shown in FIG. 1, the elastic members 4 are configured to elastically couple the input rotor 2 and the hub flange 3 therethrough. The elastic members 4 are, for instance, coil springs. As shown in FIG. 4, the elastic members 4 are accommodated in the accommodation portions 33 and 34 of the flange 32, respectively, while being supported in both radial and axial directions by the support portions 23 and 24 of the input rotor 2, respectively. It should be noted that each elastic member 4 is supported at both ends thereof by a pair of spring seats 41.

Amongst the elastic members 4, those accommodated in the first accommodation portions 33 will be referred to as first elastic members 4a, whereas those accommodated in the second accommodation portions 34 will be referred to as second elastic members 4b. The elastic members 4 are actuated in parallel.

Incidentally, all the elastic members 4 are equal in free length (Sf). The free length Sf of each elastic member 4 is equal to the length L of each support portion 23, 24 and is also equal to that of each accommodation portion 33, 34. Besides, the elastic members 4 are equal in stiffness.

### Accommodation State of Elastic Member 4

Now, a layout of the support portions 23 and 24 and the accommodation portions 33 and 34 and an accommodation state of each coil spring 4, which are made in the neutral condition, will be hereinafter explained in detail. It should be noted that in the following explanation, on an as-needed basis, a set of each first accommodation portion 33 and each opposed pair of first support portions 23 will be referred to as “first window set w1”, whereas a set of each second accommodation portion 34 and each opposed pair of second support portions 24 will be referred to as “second window set w2”.

As described above, in the neutral condition as shown in FIG. 3, each first accommodation portion 33 is offset from each opposed pair of first support portions 23 to the R1 side by the angle θ1. On the other hand, each second accommodation portion 34 is offset from each opposed pair of second support portions 24 to the R2 side by the angle θ1. Besides, each coil spring 4 is attached in a compressed state to an opening (axially penetrating hole) formed by axial overlap between each accommodation portion 33, 34 and each opposed pair of support portions 23, 24.

Specifically, in the neutral condition as shown in FIG. 3, in each of the pair of first window sets w1, each first elastic member 4a makes contact at the R1-side end surface thereof with the R1 support surfaces 231, while making contact at the R2-side end surface thereof with the R2 accommodation surface 332. In other words, each first elastic member 4a urges the input rotor 2 with respect to the hub flange 3 to the first rotation directional side R1.

On the other hand, in each of the pair of second window sets w2, each second elastic member 4b makes contact at the R1-side end surface thereof with the R1 accommodation surface 341, while making contact at the R2-side end surface thereof with the R2 support surfaces 242. In other words, each second elastic member 4b urges the input rotor 2 with respect to the hub flange 3 to the second rotation directional side R2.

### Hysteresis Generating Mechanism 6

As shown in FIG. 2, the hysteresis generating mechanism 6 includes a first bushing 61, a second bushing 62, a contact plate 63, and a cone spring 64.

The first bushing 61 is disposed axially between the first input plate 21 and the flange 32. The first bushing 61 is provided with a friction member fixed to a surface thereof making contact by friction with the first input plate 21.

The second bushing 62 and the contact plate 63 are disposed axially between the second input plate 22 and the flange 32. It should be noted that the contact plate 63 is disposed between the second bushing 62 and the flange 32. The contact plate 63 has a disc shape and includes an opening in the middle thereof. The contact plate 63 is provided with a friction member fixed to a surface thereof making contact by friction with the flange 32.

The second bushing 62 is provided with a plurality of engaging protrusions 621 axially protruding from a surface thereof located on the second input plate 22 side (see FIG. 1). The engaging protrusions 621 are engaged with a plurality of engaging holes of the second input plate 22, respectively. The cone spring 64 is disposed axially between the second bushing 62 and the second input plate 22, while being compressed therebetween.

With the configurations described above, the first bushing 61 is pressed against the first input plate 21, while the contact plate 63 is pressed against the flange 32. Therefore, when the input rotor 2 and the hub flange 3 are rotated relative to each other, a hysteresis torque is generated therebetween.

### Contact Assist Mechanism

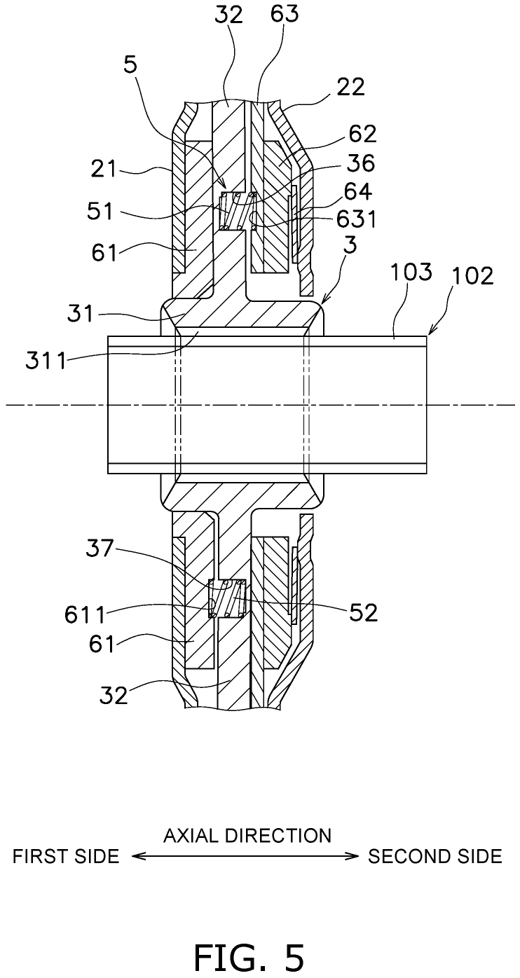

FIG. 5 is a cross-sectional closeup view for explaining the contact assist mechanism 5. The term “first side in the axial direction” means the left side in FIG. 5, whereas the term “second side in the axial direction” means the right side in FIG. 5. As shown in FIG. 5, the contact assist mechanism 5 is configured to cause contact between the internal teeth 311 of the hub flange 3 and the external teeth 103 of the input shaft 102.

The contact assist mechanism 5 is formed by an urging member. When described in detail, the contact assist mechanism 5 is composed of a first urging member 51 and a second urging member 52. The first and second urging members 51 and 52 urge the hub flange 3 to tilt the hub flange 3. Due to the tilt of the hub flange 3 caused by the first and second urging members 51 and 52, the rotational axis of the hub flange 3 is tilted with respect to that of the input shaft 102.

The first and second urging members 51 and 52 are, for instance, coil springs. The first urging member 51 urges the hub flange 3 to the first side in the axial direction. The first urging member 51 is disposed on the second side of the flange 32 of the hub flange 3 in the axial direction.

The first urging member 51 is disposed axially between the flange 32 and the contact plate 63. The flange 32 is provided with a first accommodation recess 36 on a surface thereof facing the second side in the axial direction. The first accommodation recess 36 accommodates part of the first urging member 51. On the other hand, the contact plate 63 is provided with a second accommodation recess 631 on a surface thereof facing the first side in the axial direction. The second accommodation recess 631 accommodates part of the first urging member 51.

The second urging member 52 is disposed apart from the first urging member 51 at intervals in the circumferential direction. Preferably, the second urging member 52 is disposed apart from the first urging member 51 at angular intervals of approximately 180 degrees in the circumferential direction.

The second urging member 52 urges the hub flange 3 to the second side in the axial direction. In other words, the urging direction of the second urging member 52 is opposite to that of the first urging member 51. The second urging member 52 is disposed on the first side of the flange 32 of the hub flange 3 in the axial direction.

The second urging member 52 is disposed axially between the flange 32 and the first bushing 61. The flange 32 is provided with a third accommodation recess 37 on a surface thereof facing the first side in the axial direction. The third accommodation recess 37 accommodates part of the second urging member 52. On the other hand, the first bushing 61 is provided with a fourth accommodation recess 611 on a surface thereof facing the second side in the axial direction. The fourth accommodation recess 611 accommodates part of the second urging member 52.

Due to the urge of the hub flange 3 caused by the first and second urging members 51 and 52, the hub flange 3 is tilted such that the rotational axis thereof is tilted with respect to that of the input shaft 102. This results in contact between the internal teeth 311 and the external teeth 103.

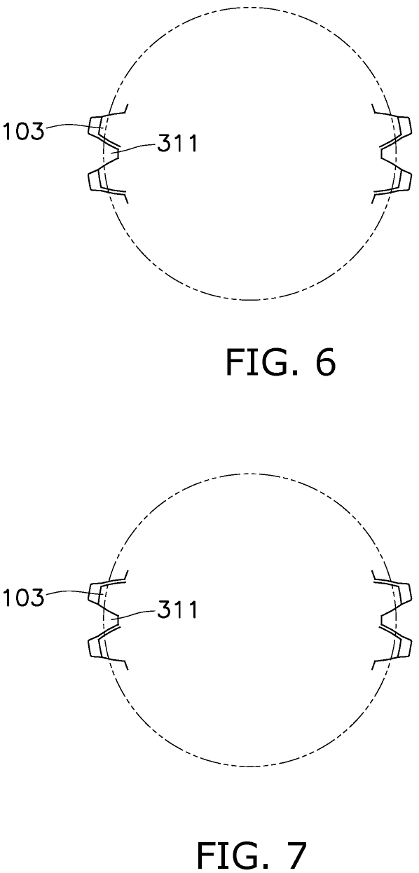

FIG. 6 is a closeup view of a contact state between the internal teeth 311 and the external teeth 103 on a first side in the axial direction. It should be noted that FIG. 6 is changed in scale for easy understanding of the contact state. As shown in FIG. 6, the internal teeth 311 and the external teeth 103 are in contact with each other at midpoints circumferentially between the first and second urging members 51 and 52.

When described in detail, the relevant internal teeth 311 are in contact at tooth surfaces thereof facing the second urging member 52 (i.e., tooth surfaces facing downward in FIG. 6) with the relevant external teeth 103. Conversely, the relevant external teeth 103 are in contact at tooth surfaces thereof facing the first urging member 51 (i.e., tooth surfaces facing upward in FIG. 6) with the internal teeth 311.

FIG. 7 is a closeup view of a contact state between the internal teeth 311 and the external teeth 103 on the second side in the axial direction. It should be noted that FIG. 7 is changed in scale for easy understanding of the contact state. As shown in FIG. 7, the internal teeth 311 and the external teeth 103 are in contact with each other at midpoints circumferentially between the first and second urging members 51 and 52.

When described in detail, the relevant internal teeth 311 are in contact at tooth surfaces thereof facing the first urging member 51 (i.e., tooth surfaces facing upward in FIG. 7) with the external teeth 103. Conversely, the external teeth 103 are in contact at tooth surfaces facing the second urging member 52 (i.e., tooth surfaces facing downward in FIG. 7) with the internal teeth 311.

As described above, the hub flange 3 is urged to tilt by the first and second urging members 51 and 52; hence, the internal teeth 311 and the external teeth 103 are in contact with each other. As a result, even when engine rotation fluctuates in a no-load condition, the internal teeth 311 and the external teeth 103 can be kept in contact with each other, whereby collision sounds can be prevented from being produced between the internal teeth 311 and the external teeth 103. It should be noted the term “no-load condition” means a condition without a torque to be transmitted by the damper device 100.

### Modifications

The present invention is not limited to the preferred embodiment described above and a variety of changes or modifications can be made without departing from the scope of the present invention.

(a) In the preferred embodiment described above, the contact assist mechanism 5 is composed of the first and second urging members 51 and 52. However, the configuration of the contact assist mechanism is not limited to this. For example, the contact assist mechanism can be composed of the first and second elastic members 4a and 4b described above.

In this case, an urging force applied by each first elastic member 4a to urge the hub flange 3 in the first rotational direction is set to be larger in magnitude than that applied by each second elastic member 4b to urge the hub flange 3 in the second rotational direction. In other words, each first elastic member 4a is set to be larger in stiffness than each second elastic member 4b. When the elastic members 4a and 4b are coil springs, each first elastic member 4a is set to be greater in spring constant than each second elastic member 4b.

The configurations described above result in a condition that the hub flange 3 is urged in the first rotational direction, whereby the internal teeth 311 of the hub flange 3 and the external teeth 103 of the input shaft 102 are in contact with each other. As a result, even when engine rotation fluctuates in a no-load condition, the internal teeth 311 and the external teeth 103 can be kept in contact with each other, whereby collision sounds can be prevented from being produced between the internal teeth 311 and the external teeth 103.

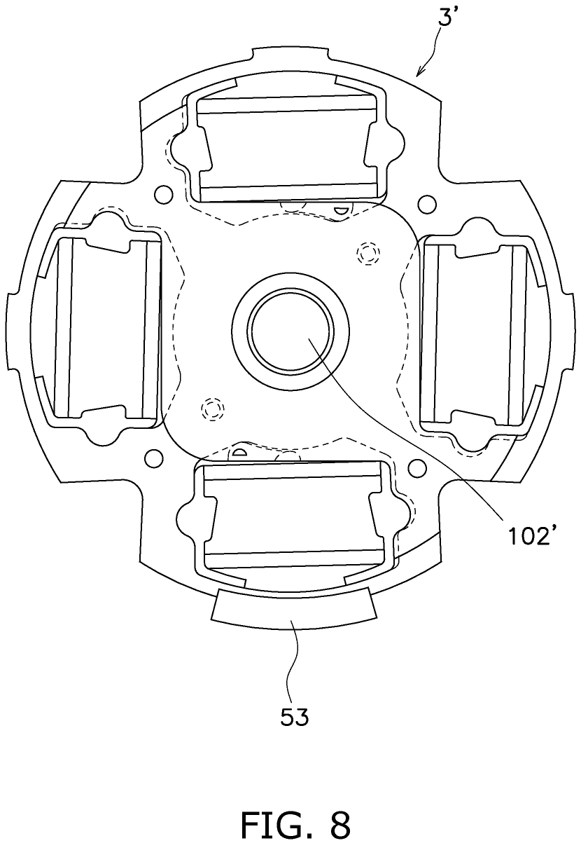

(b) In the preferred embodiment described above, the contact assist mechanism 5 is composed of the first and second urging members 51 and 52. However, the configuration of the contact assist mechanism is not limited to this. For example, as shown in FIG. 8, a weight member 53 can be provided as a contact assist mechanism 5'. The weight member 53 is attached to part of the outer peripheral portion of a hub flange 3'. In other words, the weight member 53 does not extend over the entire circumference of the outer peripheral portion of the hub flange 3'.

Thus, the weight member 53 is attached to only part of the outer peripheral portion of the hub flange 3', whereby the rotation of the hub flange 3' becomes eccentric. In other words, the rotational axis of the hub flange 3' is displaced from that of an input shaft 102'. Because of this, when the damper device is rotated, the internal teeth of the hub flange 3' and the external teeth of the input shaft 102' are in contact with each other at a position apart from the attached position of the weight member 53 by an angular interval of 180 degrees. As a result, even when engine rotation fluctuates in a no-load condition, the internal teeth and the external teeth can be kept in contact with each other, whereby collision sounds can be prevented from being produced between the internal teeth and the external teeth.

### REFERENCE SIGNS LIST

2: Input rotor
3: Hub flange
11: Internal teeth
4: Elastic member
4a: First elastic member
4b: Second elastic member
5: Contact assist mechanism
51: First urging member
52: Second urging member
53: Weight member
100: Damper device
102: Input shaft
103: External teeth

What is claimed is:

1. A damper device configured to be attached to a power transmission shaft including external teeth, the damper device comprising:
a hub flange including internal teeth configured to be meshed with the external teeth of the power transmission shaft;
an input rotor disposed to be rotatable relative to the hub flange;
an elastic member configured to elastically couple the input rotor and the hub flange; and
a contact assist mechanism configured to cause contact between the internal teeth of the hub flange and the external teeth of the power transmission shaft.

2. The damper device according to claim 1, wherein the contact assist mechanism is an urging member configured to urge the hub flange to tilt the hub flange such that a rotational axis of the hub flange is tilted with respect to a rotational axis of the power transmission shaft.

3. The damper device according to claim 2, wherein the urging member includes
a first urging member configured to urge the hub flange to a first side in an axial direction, and
a second urging member configured to urge the hub flange to a second side in the axial direction, the second urging member disposed apart from the first urging member at an interval in a circumferential direction.

4. The damper device according to claim 1, wherein
the elastic member includes
a first elastic member disposed in a compressed state to urge the input rotor in a first rotational direction, and
a second elastic member disposed in a compressed state to urge the input rotor in a second rotational direction, the second elastic member smaller in stiffness than the first elastic member, and
the contact assist mechanism is formed by the first and second elastic members.

5. The damper device according to claim 1, further comprising:
a weight member attached to part of an outer peripheral end portion of the hub flange, wherein the contact assist mechanism is formed by the weight member.
